(19) United States
(12) Patent Application Publication
(10) Pub. No.: US 2026/0225636 A1
(43) Pub. Date: Aug. 6, 2026

(54) TRANSPORT ASSEMBLY

(71) Applicant: The Stanley Works Israel Ltd., Rosh Ha-Ayin (IL)

(72) Inventors: Adar Omry, Hertzeliya (IL); Amit Ran, Mazkeret Batya (IL)

(21) Appl. No.: 19/460,761

(22) Filed: Jan. 27, 2026

Related U.S. Application Data
(60) Provisional application No. 63/753,146, filed on Feb. 3, 2025.

(51) Int. Cl. B62B 5/00; B62B 3/02

(52) U.S. Cl. CPC B62B 5/0083; B62B 3/02; B62B 2202/12

(57) ABSTRACT

A transport assembly is provided that includes a support structure having first and second elongate support members operatively engaged with one another and movable between an expanded configuration and a collapsed configuration. A plurality of wheels are coupled to the support structure and configured to allow rolling movement of the support structure along a surface when the support structure is in the expanded configuration. A connection assembly includes a plurality of connectors positioned on the support structure. Each of the plurality of connectors defines a recess configured to releasably engage with an object when the support structure is in the expanded configuration such that the support structure is configured to support the object during rolling movement of the support structure along the surface.

### CROSS-REFERENCE TO RELATED APPLICATIONS

This application claims priority under 35 U.S.C. § 119(e) to U.S. Provisional Application No. 63/753,146 filed Feb. 3, 2025, the entire contents of which are hereby expressly incorporated by reference herein.

### FIELD

A transport assembly for conveying one or more objects is provided.

### BACKGROUND

Transport assemblies can be used to move objects from one location to another. Transport assemblies can include wheels coupled to a base structure configured to receive and secure an object thereon for transport over a surface. Existing transport assemblies often include static configurations and lack suitable connection mechanisms to safely secure objects thereto. Thus, existing transport assemblies lack the flexibility to be reconfigured depending on the storage or transport requirements and can fail to securably couple objects of different dimensions or shapes for safe, efficient transport.

### SUMMARY

Various transport assemblies are provided. In one aspect, a transport assembly is provided that includes a support structure having first and second elongate support members operatively engaged with one another and movable between an expanded arrangement and a collapsed arrangement. The transport assembly can include a plurality of wheels coupled to the support structure and arranged to allow rolling movement of the support structure along a surface when the support structure can be in the expanded arrangement. The transport assembly can include a connection assembly including a plurality of connectors positioned on the support structure. Each of the plurality of connectors can define a recess arranged to releasably engage with an object when the support structure can be in the expanded arrangement such that the support structure can be arranged to support the object during rolling movement of the support structure along the surface.

In some aspects, the first and second elongate support members can be operatively engaged with one another by a pivot joint.

In some aspects, the pivot joint can include a first arc-shaped slot extending through the first elongate support member and a second arc-shaped slot extending through the second elongate support member.

In some aspects, a first pin can extend from a first side of the second elongate support member into the first arc-shaped slot and a second pin can extend from a second side of the first elongate support member into the second arc-shaped slot, the first side of the second elongate support member opposite the second side of the first elongate support member.

In some aspects, at least one of the first arc-shaped slot and the second arc-shaped slot can include a protrusion arranged to secure the first and second elongate members in the expanded arrangement.

In some aspects, the plurality of wheels can include a first pair of wheels positioned at opposite ends of the first elongate support member and a second pair of wheels positioned at opposite ends of the second elongate support member.

In some aspects, each of the plurality of connectors can be positioned adjacent to one of the plurality of wheels.

In some aspects, each of the plurality of connectors can include a first pair of connectors positioned at opposite ends of the first elongate support member and a second pair of connectors positioned at opposite ends of the second elongate support member.

In some aspects, when the support structure can be in the collapsed arrangement, each of the first and second pair of connectors can be angularly oriented relative to one another, and when the support structure can be in the expanded arrangement, a first connector of the first pair of connectors and a first connector of the second pair of connectors can be longitudinally aligned and a second connector of the first pair of connectors and a second connector of the second pair of connectors can be longitudinally aligned.

In some aspects, when the support structure can be in the collapsed arrangement, the first connector of the first pair of connectors and the second connector of the first pair of connectors can extend substantially parallel to the first connector of the second pair of connectors and the second connector of the second pair of connectors.

In some aspects, the plurality of connectors can be angularly oriented relative to one another when the support structure can be in the collapsed arrangement.

In another aspect, a transport assembly can be provided. The transport assembly can include a first support unit, including a first side and a second side. The transport assembly can include a first connection assembly positioned on the first side of the first support unit, the first connection assembly including a first connector having a first recess and a second connector having a second recess. The transport assembly can include a first wheel connected at a first end of the second side of the first support unit. The transport assembly can include a second wheel connected at a second end, opposite the first end, of the second side of the first support unit. The transport assembly can include a second support unit, including a first side and a second side. The transport assembly can include a second connection assembly positioned on the first side of the second support unit, the second connection assembly including a third connector having a third recess and a fourth connector having a fourth recess. The transport assembly can include a third wheel connected at a first end of the second side of the second support unit. The transport assembly can include a fourth wheel connected at a second end, opposite the first end, of the second side of the second support unit. The transport assembly can include a hinge assembly. The hinge assembly can include a first rod extending from the second side of the first support unit into a first slot of the second support unit, and a second rod extending from the first side of the second support unit into a second slot of the first support unit.

In some aspects, the second side of the first support unit and the first side of the second support unit can include a recess substantially mid-way between the first and second ends of the first and second support units.

In some aspects, the first and second support units can be moveable between a collapsed position and an expanded position responsive to articulation of the hinge assembly around a pivot point defined by a third rod extending through the first and second support units.

In some aspects, the first and second recesses of the first and second connectors can be arranged to retain an object therein.

In some aspects, the first and second slots can include an arc-shaped slot defining a range of motion of first and second support units relative to one another.

In some aspects, at least one arc-shaped slot can include a protrusion defining a terminal position of the range of motion, the protrusion arranged to secure the second rod within the slot when the first and second support units can be in an expanded position.

In another aspect, a transport system can be provided. The transport system can include a transport assembly, including a first elongate support member and a second elongate support member coupled to one another via a hinge assembly positioned substantially mid-way along the first and second elongate support members and extending therethrough. The hinge assembly can be arranged to move the first and second elongate support members between a collapsed position and an expanded position. Each of the first and second elongate support members can include first and second wheels and first and second connectors positioned at opposing ends thereof. The transport system can include at least one container arranged to releasably couple with the transport assembly. The at least one container can have a plurality of sidewalls extending therearound between a top wall and a bottom wall of the at least one container and defining an inner volume of the container. The transport assembly can be arranged to be retained within the inner volume when the hinge assembly can be in the collapsed position and to receive the at least one container thereupon such that bottom wall can be releasably coupled with the first and second connectors of the first and second elongate support members when the hinge assembly can be in the expanded position.

In some aspects, the bottom wall of the at least one container can include a plurality of projections extending along opposing edges of the bottom wall and arranged to be received within the first and second connectors of the first and second elongate support members.

In some aspects, in the collapsed position, recesses of the first and second connectors of the first elongate support member can be angled relative to recesses of the first and second connectors of the second elongate support member and in the expanded position, the recesses of the first and second connectors of the first elongate support member can be opposite to the recesses of the first and second connectors of the second elongate support member.

In another aspect, a transport assembly can be provided. The transport assembly can include a first support member, a second support member, and a hinge assembly coupling the first and second support members. The hinge assembly can be arranged to translate the first and second support members between an expanded state in which a connector on at least one of the first and second support members can be releasably coupled to at least one surface of a container and a collapsed state in which the transport assembly can be received within a cavity of the container.

In another aspect, a transport unit can be provided. The transport unit can include a container having an opening leading into an inner compartment. The transport unit can include a lid having a plurality of wheels coupled thereto. The lid can be arranged to be positioned in a first arrangement in which the lid covers the opening and the plurality of wheels can be positioned within the inner compartment, and a second arrangement in which the lid can be detachably coupled to a bottom wall of the container and the wheels can be positioned to allow rolling movement of the container across a surface.

In some aspects, the plurality of wheels can include detachable caster wheels arranged to couple to the lid or the bottom wall of the container.

In some aspects, the plurality of wheels can include detachable articulating caster wheels arranged to couple to the lid or the bottom wall of the container.

In some aspects, the plurality of wheels can include fixed caster wheels or fixed articulating caster wheels coupled to the lid.

In some aspects, the lid and the bottom wall of the container can be detachably coupled via a hinge assembly.

In some aspects, the lid and the bottom wall of the container can be detachably coupled via a latch assembly.

### DESCRIPTION OF DRAWINGS

These and other features will be more readily understood from the following detailed description taken in conjunction with the accompanying drawings, in which:

FIG. 1 is perspective view of a transport assembly in a collapsed configuration;

FIG. 2 is a perspective view of the transport assembly of FIG. 1 in an expanded configuration;

FIG. 3 is a detailed view of a hinge assembly of the transport assembly of FIG. 2;

FIG. 4 is a bottom perspective view of the transport assembly of FIG. 2;

FIG. 5 is a detailed perspective view of the hinge assembly of the transport assembly of FIG. 5;

FIG. 6A is a top exploded view of the hinge assembly of transport assembly of FIG. 2;

FIG. 6B is a bottom exploded view of the hinge assembly of FIG. 6A;

FIG. 7A is a perspective view of a connector of the transport assembly of FIGS. 1 and 2;

FIG. 7B is a side view of the connector of FIG. 7A;

FIG. 7C is a rear view of the connector of FIG. 7A;

FIG. 8 is a perspective view of a transport system including a transport assembly as described herein in the collapsed configuration illustrated in FIG. 1 and a container configured for use with the transport assembly of FIGS. 1-2;

FIG. 9 is a front perspective view of a bottom portion of the container of FIG. 8;

FIG. 10 is a rear perspective view of a bottom portion of the container of FIG. 8;

FIG. 11 is a front perspective view of the transport system of FIG. 8 with the container coupled to the transport assembly in the expanded configuration illustrated in FIG. 2;

FIG. 12 is a rear perspective view of the transport system of FIG. 8 with the container coupled to the transport assembly in the expanded configuration illustrated in FIG. 2;

FIG. 13 is a cross-sectional view of the transport system of FIG. 12 taken along lines B-B of FIG. 12;

FIG. 14 is a detailed cross-sectional view of a front portion of the transport system of FIG. 13;

FIG. 15 is a detailed cross-sectional view of a rear portion of the transport system of FIG. 13;

FIG. 16 is a perspective view of another embodiment of a transport system illustrating a transport assembly configured to detachably couple with a container as described herein;

FIG. 17 is another perspective view of the transport system of FIG. 16;

FIG. 18 is a perspective view of the transport system of FIG. 16 with the transport assembly attached to the container;

FIG. 19 is a perspective view of the transport assembly of FIG. 16 with the wheels in a storage configuration;

FIG. 20 is a perspective view of the transport assembly of FIG. 16 with the wheels in a deployed configuration;

FIG. 21 is an isometric view of another container according to the subject matter described herein;

FIG. 22 is an isometric view of a container assembly including the container of FIG. 21 with wheels coupled to the bottom wall thereof and with another container securely coupled thereto; and

FIG. 23 is a front view of the container assembly of FIG. 22.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. A person skilled in the art will also recognize that a value may not be precisely at a value but nevertheless considered to be substantially at that value due to any number of factors, such as manufacturing tolerances and sensitivity of measurement equipment.

A transport assembly and system is provided that includes a configurable transport solution that provides an easily stored and deployed base platform that includes connector components configured to safely couple with a transport container. The transport assembly can easily transition from a collapsed configuration, as it might be stored, to an expanded configuration, when in use for transport. The transport assembly can be easily secured to the object without requiring mechanically complicated or additional coupling mechanisms. When used in conjunction with a transport container described herein, the transport system can enable easy and secure coupling of connection components on the container with corresponding connection components on the transport assembly. Thus, the transport assembly and system herein advantageously provide a configurable transport device for transporting objects that can be easily and effectively secured thereto.

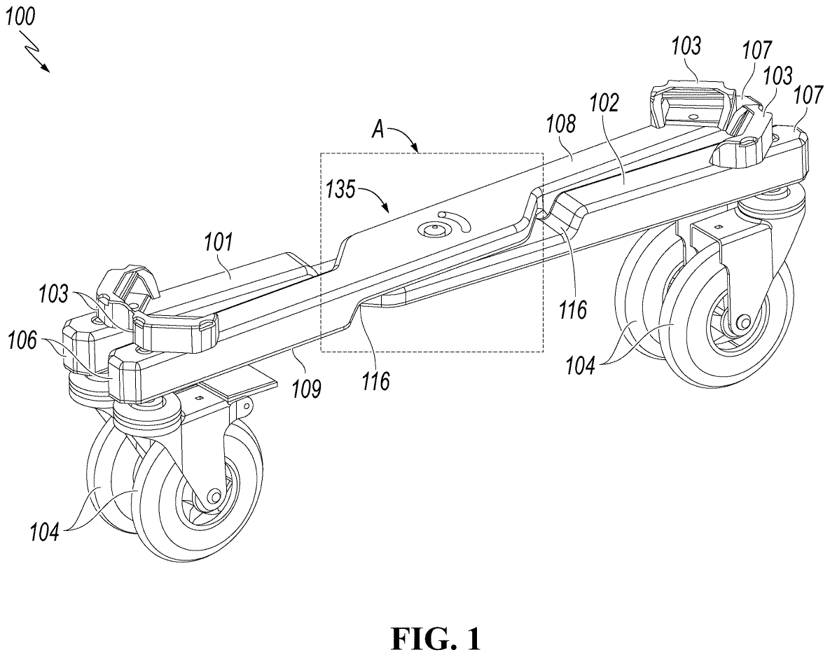

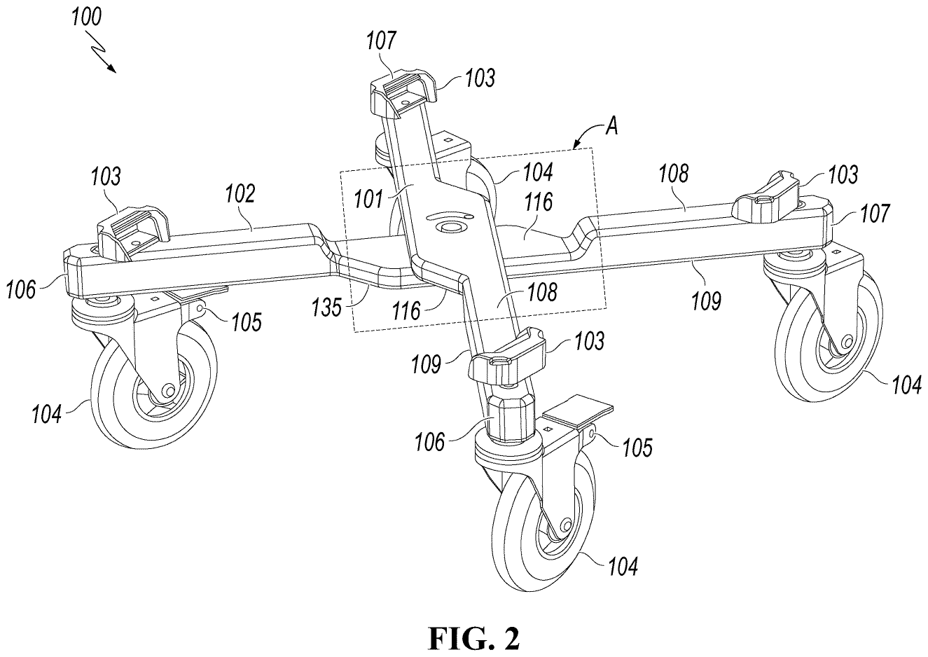

FIGS. 1-7C illustrate embodiments of a transport assembly and components thereof configured to transition between a collapsed configuration and an expanded configuration and to secure or couple an object to be transported thereto. As shown in FIGS. 1 and 2, a transport assembly 100 is provided. The transport assembly 100 is shown in a collapsed configuration in FIG. 1 as might be used during storage of the transport assembly, and is shown in an expanded configuration in FIG. 2 for transporting objects. The illustrated transport assembly 100 includes a first support structure 101 and a second support structure 102 coupled to one another via a hinge assembly 135. The first and second support structures 101, 102 can be elongate members that have connectors 103 and wheels 104 at each of the first end 106 and the second end 107. Each support structure 101, 102 can include a first side 108 and a second side 109 that is opposite the first side 108. Although the support structures 101, 102 are shown having a substantially square or rectangular cross-sectional shape, other cross-sectional shapes can be envisioned.

One or both support structures 101, 102 can include a recessed portion 116 configured approximately mid-way along their length and in proximity of the hinge assembly 135. The support structures 101, 102 can transition from a substantially square or rectangular cross-sectional shape adjacent to the first and second ends 106, 107 to a substantially widened flat planar shape at the recessed portions 116. The recessed portions 116 can be configured to reduce an overall height of the transport assembly 100 and to provide greater rigidity and structural integrity of the hinge assembly 135 by providing large planar surfaces 110 at which the support structures 101, 102 interface.

As further shown in FIGS. 1 and 2, the transport assembly 100 can include a connection assembly including connectors 103. The connectors 103 can be fixedly positioned on the first side 108 adjacent to the ends 106, 107 of the support structures 101, 102. In some embodiments, the connectors 103 can be freely rotatably coupled to the first side 108. As shown in FIG. 1, when the transport assembly is in the collapsed configuration, the connectors 103 can be angled relative to one another. As shown in FIG. 2, when the transport assembly is in the expanded configuration, the connectors 103 can be co-planar or parallel to one another. As will be described later, the connectors 103 can be configured to receive an object for transport therein.

The transport assembly 100 can also include a plurality of wheels 104 coupled to the second side 109 of the support structures 101, 102 at the first and second ends 106, 107 thereof. One or more of the wheels 104 can include a lock mechanism 105 that can prevent the wheel 104 from rotating. The wheels 104 can rotate relative to the support structures 101, 102 to allow the transport assembly 100 to easily maneuver over a surface.

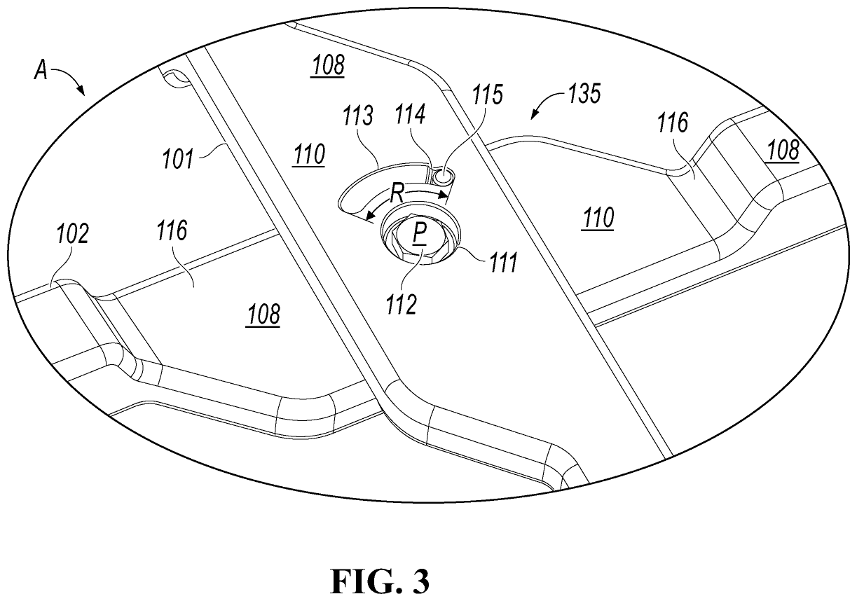

The hinge assembly 135, shown in region A surrounded by the dashed lines in FIGS. 1 and 2, can enable the transport assembly 100 to transition between the collapsed configuration shown in FIG. 1 and the expanded configuration shown in FIG. 2. FIG. 3 is a detailed top view of region A illustrating the hinge assembly 135 shown in the expanded configuration. The hinge assembly 135 can be configured to couple the support structures 101, 102 within the recessed portion 116 thereof. A second side 109 of support structure 101 can be juxtaposed on a first side 108 of support structure 102 such that corresponding planar surfaces 110 of the support structured 101, 102 interface one another. A planar surface 110 of support structure 101 can be located on the second side 109 thereof and a planar surface 110 of the support structure 102 can be located on the first side 108 thereof.

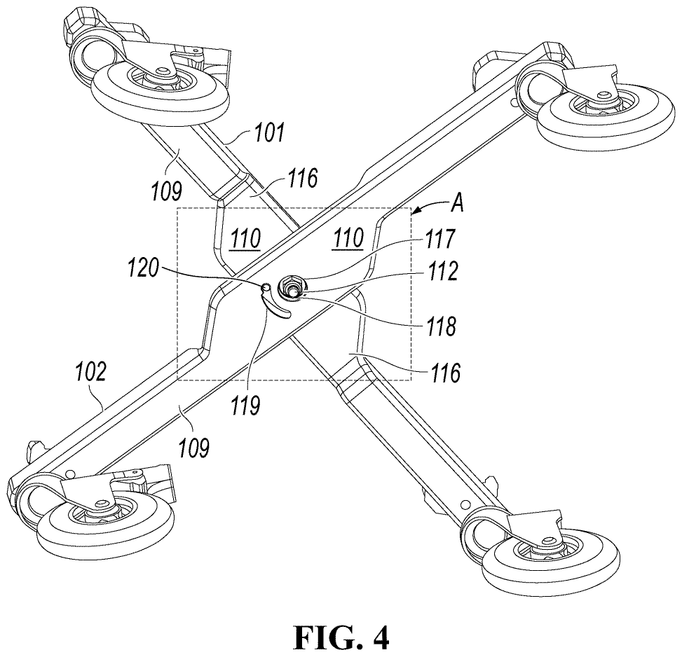

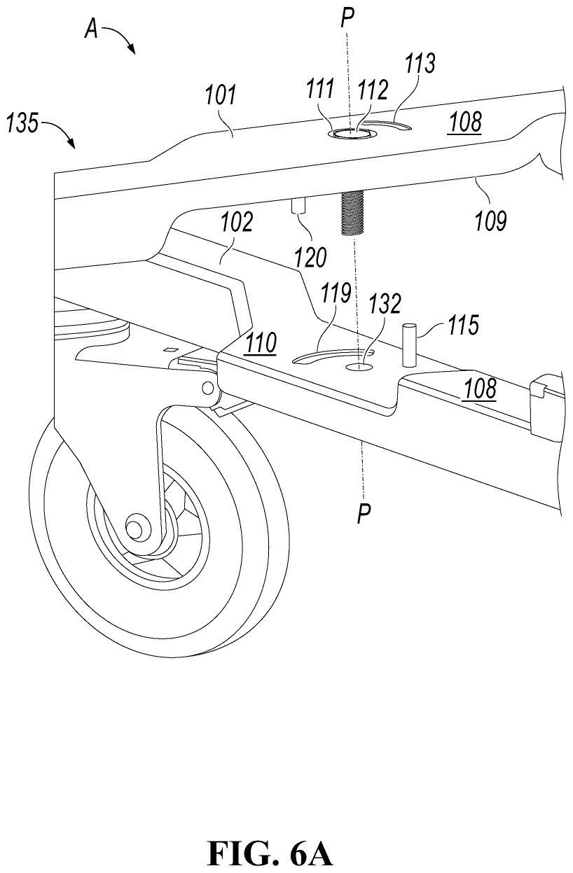

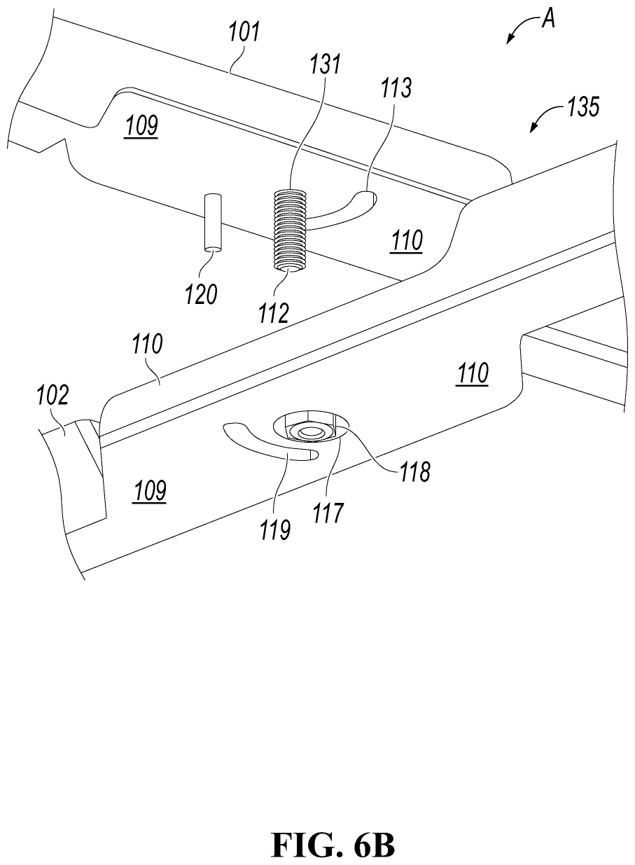

As shown in FIG. 3, the hinge assembly 135 can include a recess 111 in the first side 108 of the support member 101. Within the recess 111, a hole 131 shown in FIG. 6B can extend through the support member 101 to accommodate a shaft therein that can enable the support members 101, 102 to rotate between the collapsed and expanded configurations. As shown in FIGS. 3-6B, the shaft 112 can include a bolt. The bolt 112 can extend through the second side 109 of the support structure 101 as shown in FIG. 6A and can be received within a hole 132 in the first side 108 of the support structure 102. The hole 132 can extend through the support structure 102 from the first side 108 to the second side 109 of the support structure 102. As shown in FIGS. 4, 5, and 6B, a recess 117 can be located on the second side 109 of the support structure 102 and the hole 132 can open into the recent 117. A coupling mechanism, such as a nut 118, can be coupled to the terminal end of the bolt 112 to rotatably secure the support structures 101, 102 to one another. In some embodiments, other coupling mechanisms besides a bolt and nut can be envisioned, such as a shaft having a flange at one end and a groove at an opposing end for receiving a retaining clip or ring to rotatably secure the support structures 101, 102 to one another. The size of the bolt 112, nut 118, and the recesses 111 and 117 can be configured to minimize the overall height of the hinge assembly 135.

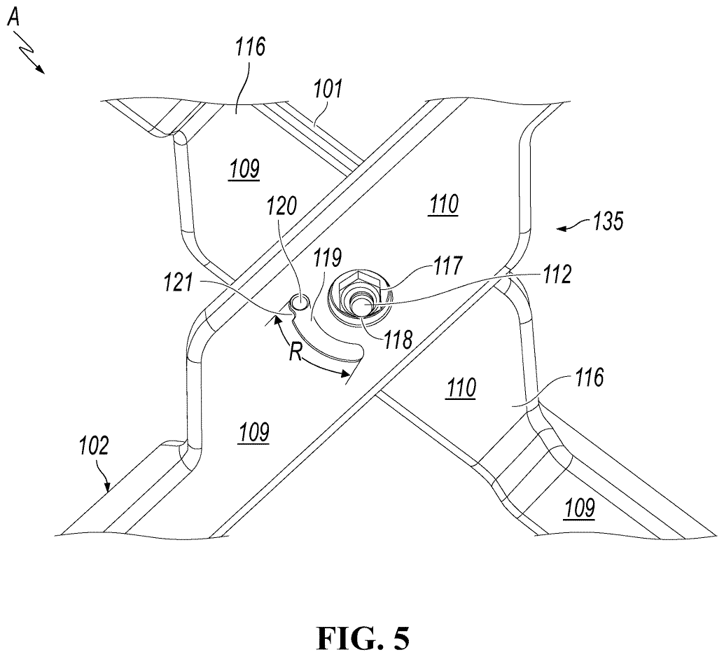

The hinge assembly 135 can also include a slots 113, 119 in which pins 115, 120 can be received and travel. For example, as shown in FIGS. 3 and 6A, the support structure 101 can include slot 113 extending therethrough from the first side 108 to the second side 109. As shown in FIGS. 4-6B, the support structure 102 can include a slot 119 extending therethrough from the first side 108 to the second side 109. The support member 101 can include a pin 120 that can extend from the second side 109 of the support structure 101. The pin 120 can be received and travel within the slot 119 of the support structure 102 as shown in FIGS. 4 and 5. The support structure 102 can include a pin 115 that can be received and travel within the slot 113 of support structure 101 as shown in FIG. 3. The slot and pin arrangement of the hinge assembly 135 can function to guide movement of the support structures 101, 102 for transitioning the transport assembly 100 from the collapsed configuration to the expanded configuration and vice versa as a user manipulates the support structures 101, 102 relative to one another.

As shown in FIGS. 3 and 5, the slots 113, 119 can be substantially arc-shaped and can define a range of motion R of the hinge assembly 135 relative to a pivot point P defined by the location of the bolt 112 as shown in FIGS. 3 and 6A. The slots 113, 119 can include a protrusion 114, 121, such as a detent, projecting from a sidewall (or integrally formed with the sidewall) of the slots 113, 119. The protrusion 114, 120 can be configured to define a terminal position of the range of motion R at which the support structures 101, 102 are securably and fully configured in the expanded configuration. The protrusion 114, 121 can act to secure the pins 115, 120 within the slots 113, 119 so that the support structures 101, 102 do not inadvertently articulate from a partially expanded configuration to the collapsed configuration. Advantageously, the protrusion 114, 121 can provide tactile feedback to a user that the support structures 101, 102 are secured and fully articulated into the expanded configuration.

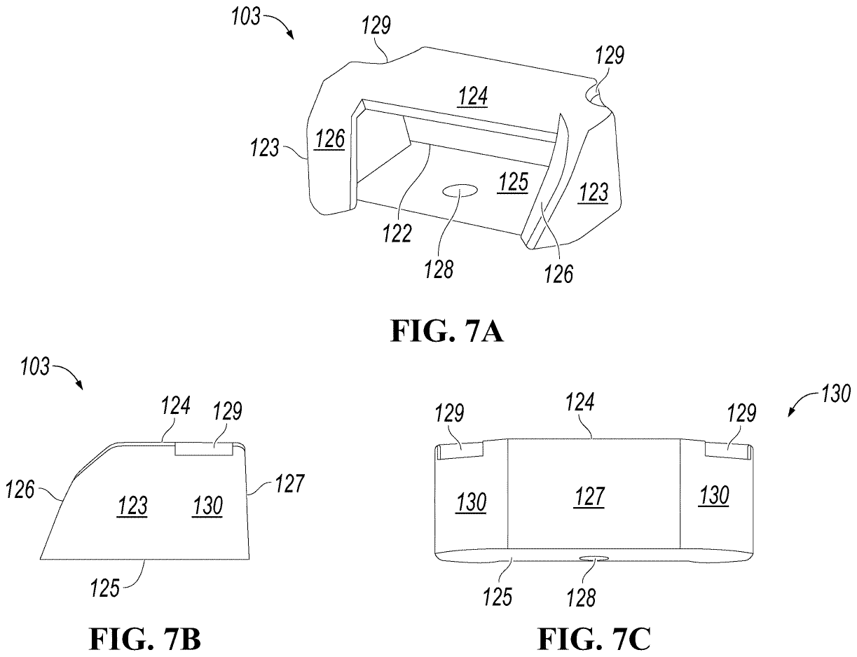

Turning to FIG. 7A-7C, views of the connector 103 are illustrated. In one embodiment as shown, the connector 103 can include a recess 122 therein, such as a rectangular cavity surround by a C-shaped sidewall. The recess 122 can be configured to receive and secure a portion of an object being transported via the transport assembly 100. The recess 122 can be formed between or within side walls 123, 124, 125, 126, 127, and 130. A number of features of the connectors 103 can be provided to aid engagement and securing of the object or an object component within the recess 122. For example, the sidewall 124 can be less wide that the sidewall 125 to provide a larger opening of the recess 122. The sidewalls 123 can include sloped portions 126 configured to guide the object into the recess 122. The sidewalls 130 can include recesses 129 configured to engage with a corresponding portion of the object or object component that can be received within the recesses 129. The connector 103 can also include a hole 128 extending through the sidewall 128. The hole 128 can receive a coupling mechanism, such as a pin, rivet, or bolt to secure the connector 103 to the support structures 101, 102 at the first and second ends 106, 107 thereof.

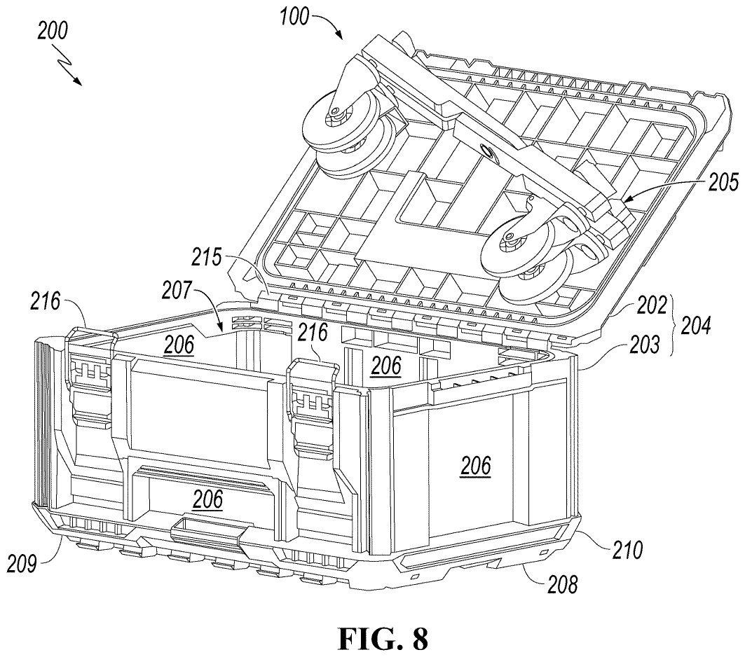

The transport assembly 100 described herein can be configured for use in transporting any container or object from one location to another. For example, the transport assembly 100 can be used to transport a tray, a work surface, a device, or a tool. The container or object and the transport assembly 100 together can form a transport system. As shown in FIG. 8, the transport system 200 includes the transport assembly 100 as described herein, shown in the collapsed configuration and one embodiment of a container 204, shown in an open configuration. The container 204 can include a lid or sidewall 202 and a container body 203 formed by four sidewalls 206 and 208. Sidewall 208 can be a bottom wall that can be opposite the lid or sidewall 202. The container 204 can include an inner volume 207 in which articles to be moved can be placed into the container 204. The container can include a first connection region 209 formed at the intersection of sidewalls 206 and 208 (e.g., at a bottom-front edge of the container 204) and a second connection region 210, opposite the first connection region 209, formed at the intersection of sidewalls 206 and 208 (e.g., a bottom-rear edge of the container 204). The lid or sidewall 202 can be coupled to the container body 203 via a hinge 215. In some embodiments, the hinge can extend fully or partially along the upper edge of sidewall 206 to couple the lid or sidewall 202 thereto. In some embodiments, the lid or sidewall 202 can be friction-fit or snap-fit to the container body 203. The container body 203 can also include one or more latches 216 that can secure the lid or sidewall 202 in a closed configuration relative to the container body 203. The latches 216 can engage corresponding portions of the lid or sidewall 202.

In some embodiments, the transport assembly 100 can be stored in the container 204 in the collapsed configuration. For example, as shown in FIG. 8, the transport assembly 100 can be positioned on a surface 205 of the lid or sidewall 202 and can be secured thereto by one or more coupling mechanisms, such as a clip, snap, bracket, or the like. In some embodiments, the transport assembly 100 can be stored within the inner volume 207 of the container 204, such as on a surface of sidewalls 206, 208 that define the inner volume 207. The transport assembly 100 can be secured thereto by one or more coupling mechanisms, such as a clip, snap, bracket, or the like. In this way, the transport assembly 100 can be stored in the container 204 in the collapsed configuration and can be removed therefrom when ready for use to transport the container 204 in the expanded configuration. As a result, the transport system provides an integrated solution for transport assembly storage and container transport.

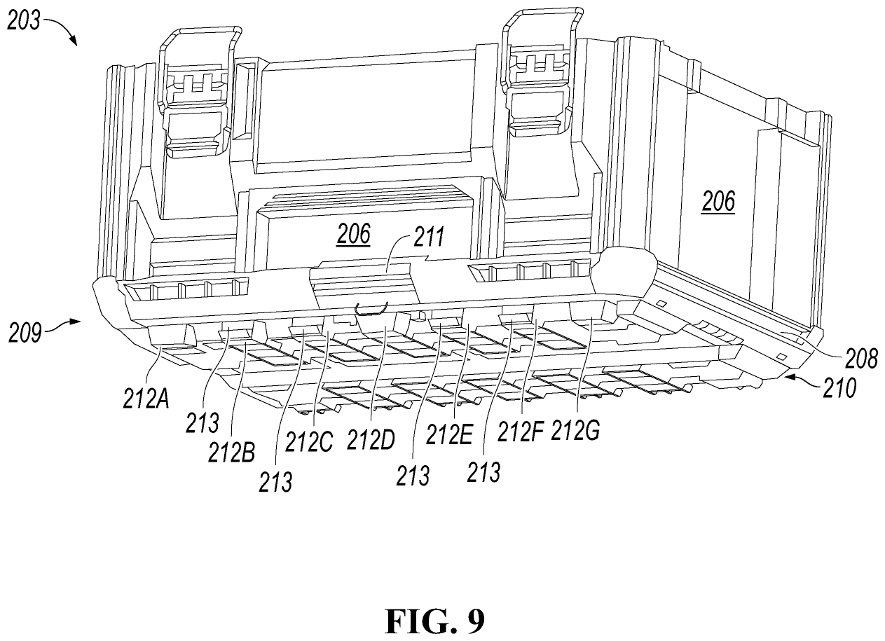

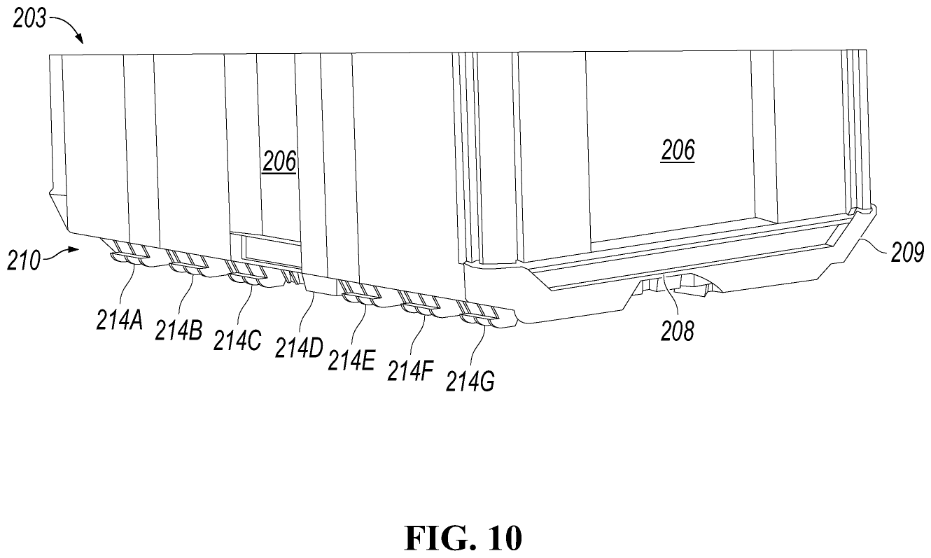

As shown in FIGS. 9 and 10, the container body 203 can include a plurality of projections 212, 214 that extend along the first and second connection regions 209, 210. For example, the first connection region 209, formed at the front-bottom edge of the container 204 can include projections 212A-212G and the second connection region 210, formed at the rear-bottom edge of the container 204 can include projections 214A-214G. Although, seven projections 212, 214 are shown, fewer or less numbers of projections 212, 214 can be configured. The projections 212, 214 are configured to be receive within the recess 122 of the connectors 103 on the support structures 101, 102 so as to secure the container 204 to the transport assembly 100.

A portion of the projections 212 in the first connection region 209 can include actuated latches 213 as shown in FIG. 9. The latches 213 can be mechanically coupled to an actuation mechanism 211 configured to actuate (e.g., to extend or retract) the latches 213 into or out of the recesses 122 of the connectors 103. The actuation mechanism 211 can be biased such that the latches 213 protrude from the projections 212 so as to engage into the recesses 122 in a first configuration and can be retracted into the projections 212 and out of the recesses 122 when the container is to be removed from connectors 103 and the transport assembly 100. As shown in FIG. 9, projections 212B, 212C, 212E, and 212F are configured with latches 213. In some embodiments, each projection 212 can include a latch 213. In some embodiments, fewer of the projections 212 can include a latch 213.

As shown in FIG. 10, the second connection region 210 can include a projections 214, such as projections 214A-214G. The projections 214 can also be configured to engage with the recess 122 of the connectors 103 of the support structures 101, 102 of the transport assembly 100 described herein. In some embodiments, the projections 214 can also include a latch 213 that can be mechanically linked to an actuation mechanism 211 of the second connection region 210 in a manner that is similar to that shown and described in relation to the projections 212 of the first connection region 209.

The number of projections 212, 214 and the spacing thereof within the first and second connection regions 209, 210 can vary. At least one longitudinal position of a projection 212, 214 within the first and second connection regions 209, 210 can correspond to a fully expanded configuration of the transport assembly 100 in which the hinge assembly 135 is full expanded. In this configuration the pins 115, 120 are secured by the protrusions 114, 121 within the slots 113, 119. The projections 212, 214 can be located at other positions within the first and second connection regions 209, 210 that can correspond to partially expanded configurations of the hinge assembly 135. Additionally, the container 204 need not be exactly centered in the transport assembly 100. For example, the transport assembly 100 could be coupled to projections 212, 214 that are closer to one end of the container 204 than the opposing end. In this way, the transport system 200 can provide flexibility in the manner in which the container 204 is coupled to the transport assembly 100, which can be useful to accommodate objects, loads, or containers 204 which can have unevenly distributed mass or weight. In some embodiments, the connection regions and components configured thereof can be configured as disclosed in U.S. Provisional Patent Application No. 63/720,735, filed Nov. 14, 2024 and entitled “Transportable Container System,” the entire contents of which is incorporated by reference herein.

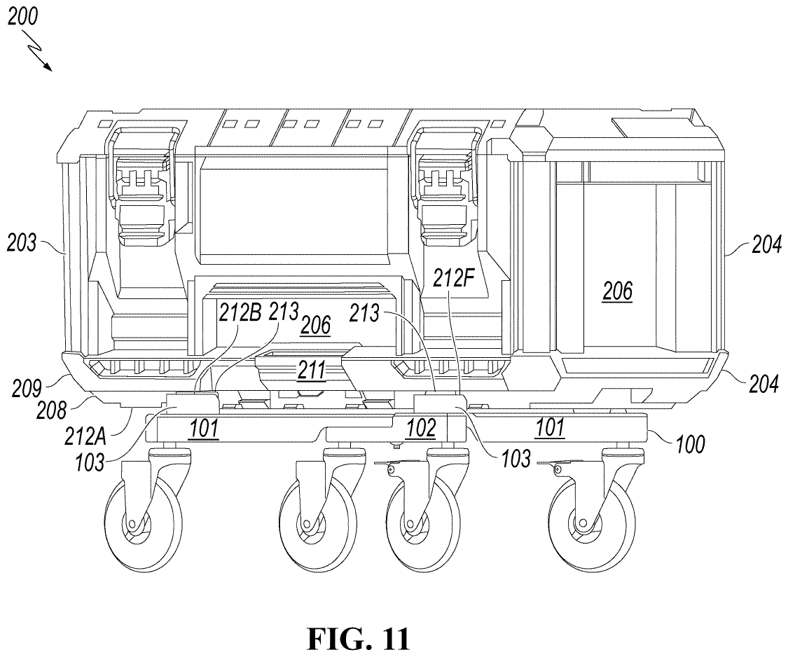

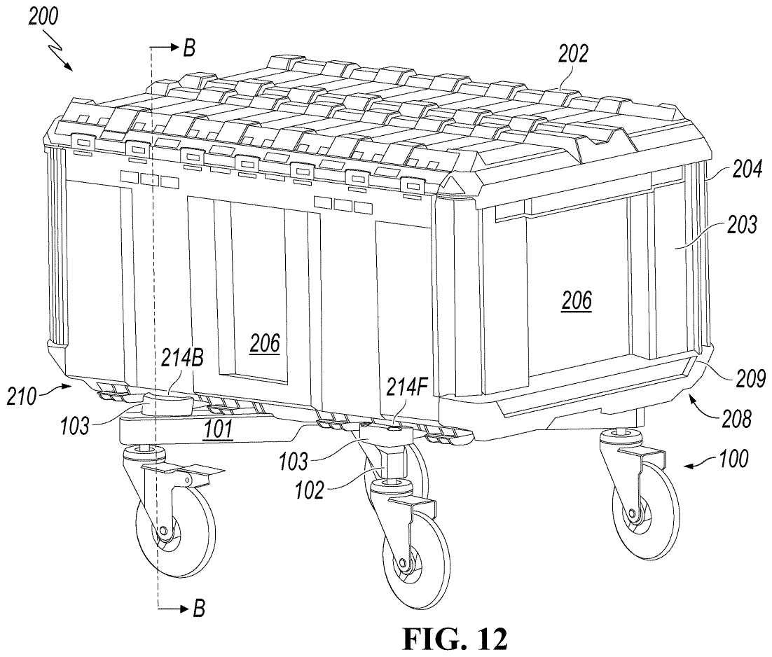

In FIGS. 11 and 12, the transport system 200 is shown with the container 204 coupled to the transport assembly 100 in the expanded configuration. As illustrated, with the first connection region 209, shown in FIG. 11, the latches 213 of projections 212B and 212F are coupled to the connectors 103 configured on support structures 101, 102 of the transport assembly 100. As shown in FIG. 12, within the second connection region 210, the projections 214B and 214F are coupled to the connectors 103 configured on support structures 101, 102 of the transport assembly 100.

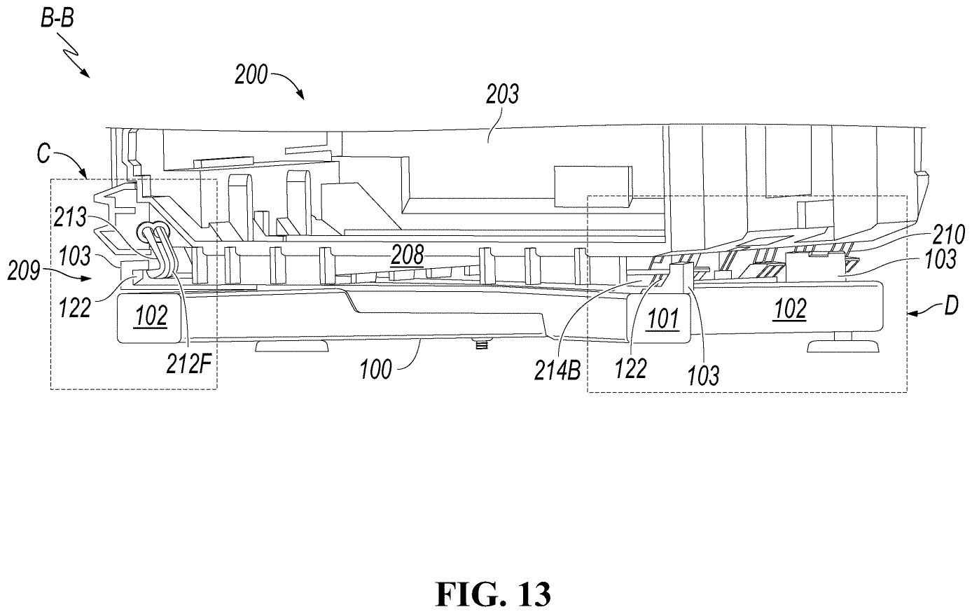

In FIG. 13, a cross-sectional view of the transport system 200 is shown taken along lines B-B of FIG. 12. The first connection region 209 is shown in region C surrounded by dashed lines and the second connection region 210 is shown in region D, also surrounded by dashed lines. The cross-sectional view of regions C and D illustrate the coupling of the projections 212, 214 with the connectors 103 of the transport assembly 100. For example, as shown in region C, the latch 213 of projection 212F is shown as received within the cavity 122 of the connector 103 of support structure 102. As shown in region D, the projection 214B is shown as received within the cavity 122 of connector 103 of support structure 101.

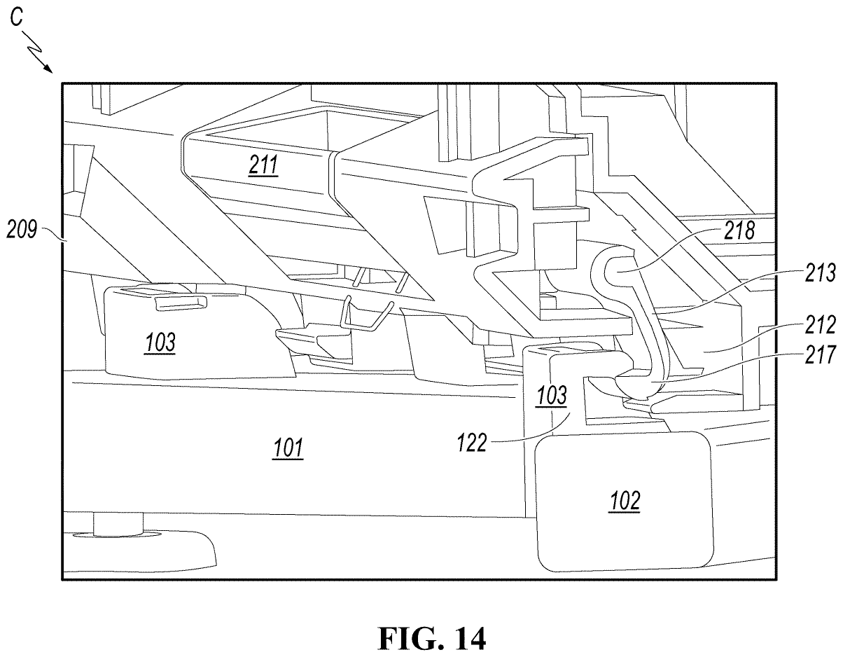

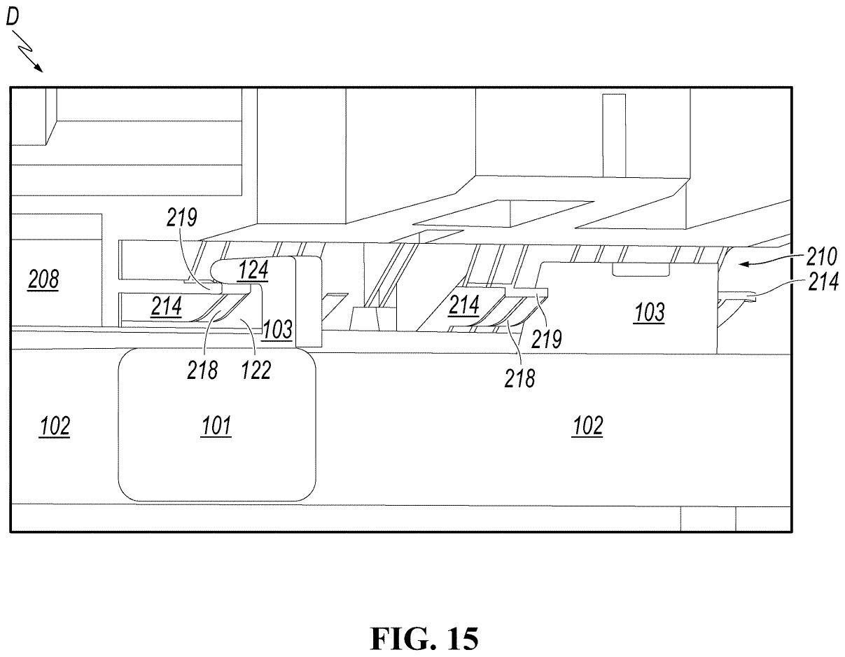

A detailed view of region C (shown in FIG. 13) is shown in FIG. 14 illustrating the mechanical coupling of the latch 213 to the actuation mechanism 211 and the coupling of the latch 213 and the connector 103 withing the first connection region 209. The actuation mechanism 211 can be coupled to a shaft or axle 218 that can be coupled to the latch 213. With the actuation mechanism 211 in the closed position as shown, the latch 213 is fully engaged in the recess 122. The latch 213 can include a hook-shaped terminal portion 217 that can be configured to engage with a rib or similar structure in the recess 122 to provide enhanced coupling and security of the connection between the latch 213 and the connector 103. When the actuation mechanism 211 is in the open position, the latch 213 can retract the terminal portion 217 out of the recess 122 to enable the container 204 to be uncoupled from the connector 103 and the transport assembly 100.

A detailed view of region D (shown in FIG. 13) is shown in FIG. 15 to illustrate the coupling of the projection 214 and the connector 103 within the second connection region 210. The projection 214 can include a first surface 218 and a second surface 219. The first surface 218 can be sloped relative the second surface 219. The second surface 219 can be substantially co-planar with the sidewall 208. The first surface 218 can be angled or sloped to assist positioning the projection 214 within the recess 122 of the connector 103. For example, the sloped first surface 218 can aid positioning the container 204 on the transport assembly 100 such that the projections 214 are more easily received within the recess 122 of the connectors 103. In some embodiments, the second surface 219 can include a rib or projection thereon to engage with a corresponding rib or groove on a surface of the sidewall 124 of the connector 103 that abuts the second surface 219 to provide a snap-fit or friction-fit of the projection 214 within the recess 122.

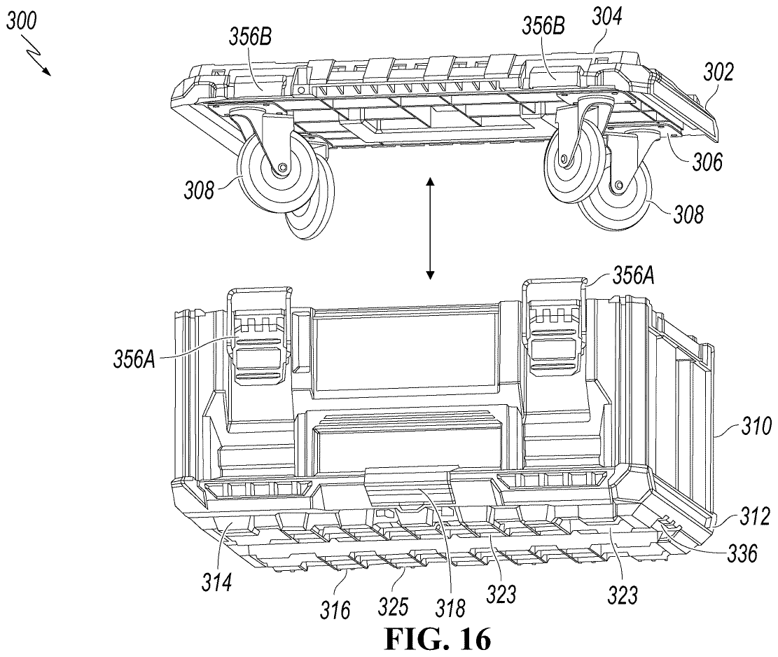

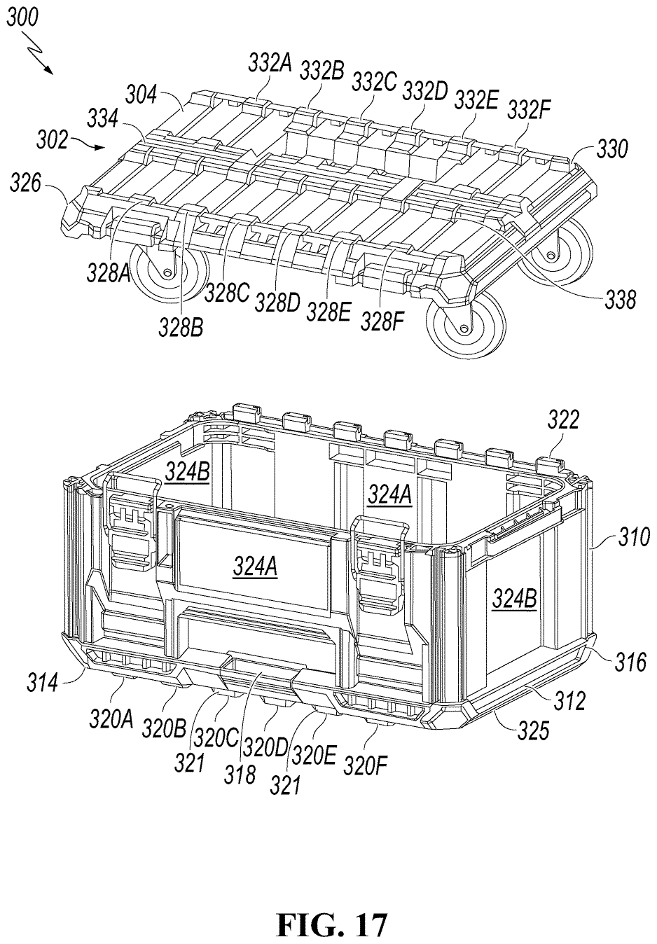

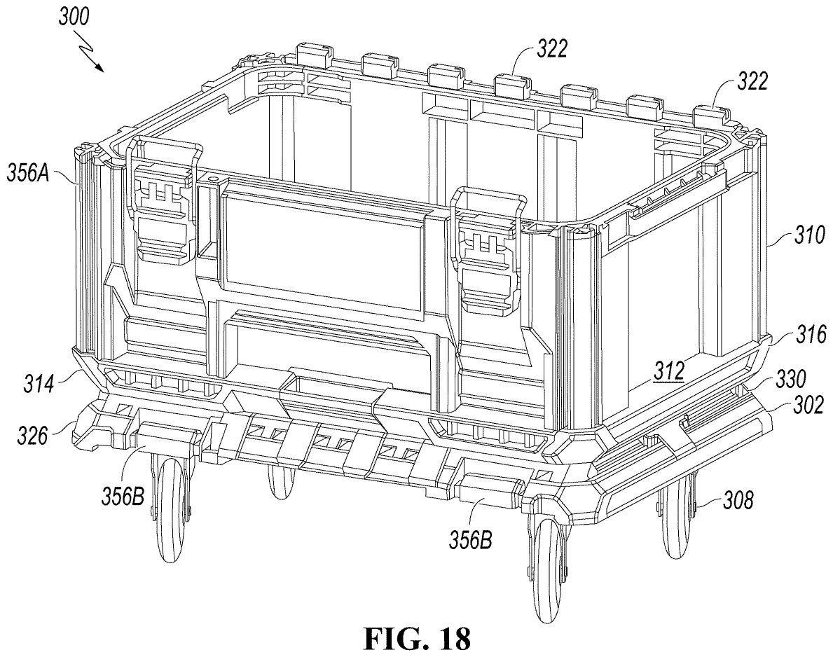

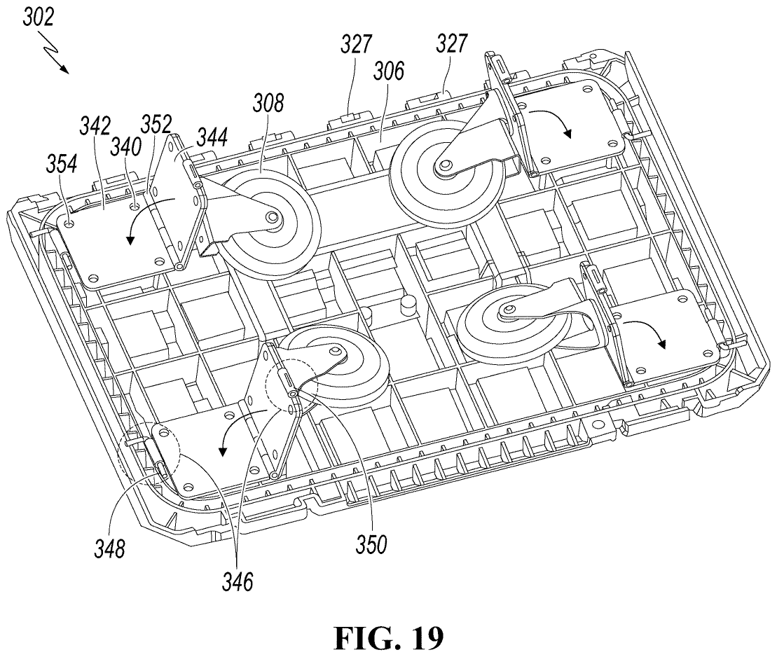

Another embodiment of a transport system is shown and described in relation to FIGS. 16-20. In this embodiment, the transport system includes a lid that can also function as a transport assembly. As shown, the transport system 300 includes a lid 302 that can detachably and releasably couple with a container 310. The lid 302 can be removed from a top portion of the container 310 and can be coupled to a bottom portion of the container 310 where it can function as a transport device, thus converting the container to a rolling container with wheels. The lid 302 can include a first side 304 and a second side 306 opposite the first side. The lid 302 can include a plurality of wheels 308 positioned on the second side 306. In some embodiments, when the lid 302 is coupled to the container 310 to cover the opening thereof, the second side 306 of the lid 302 faces inward toward an inner volume of the container 310 such that the wheels 308 are positioned within an inner compartment of the container 310. In this way, the wheels 308 may be received within the inner compartment when the lid 302 covers the opening, and may be positioned to allow rolling movement of the container 310 across a surface when the lid 302 is detachably coupled to the bottom wall of the container 310. The container 310 can correspond to the container 204 of the transport system 200 shown and described earlier, except where noted otherwise herein. The lid 302 can be coupled to the container 310 via one or more connection elements 322 as shown in FIG. 17. The lid 302 can include one or more lid connection elements 327 as shown in FIG. 19. In some embodiments, the connection elements 322, 327 can include latching elements, such as latching elements 356 shown in FIGS. 16 and 18. For example, the latching element 356A can be configured on the container 310 and a corresponding latching element 356B can be configured on the lid 302. The latching elements 356 (such as corresponding latching element 356A and 356B) can be configured to secure the lid 302 to container 310 so as to enclose the opening of the container in a first configuration and also to detachably couple the lid 302 to the bottom of the container 310 in a second configuration for moving the container 310 across a surface as shown in FIG. 18.

In some embodiments, the connection elements 322, 327 can include hinge elements as shown in FIGS. 17-19. For example, a first hinge element can be configured on the container 310 and a corresponding second hinge element can be configured on the lid 302. Hinge elements can be configured to secure the lid 302 to container 310 so as to enclose the opening of the container in a first configuration and also to detachably couple the lid 302 to the bottom of the container 310 in a second configuration as shown in FIG. 18 for moving the container 310 across a surface. In some embodiments, the connection elements 322, 327 can include snap-fit elements, friction-fit elements, or the similar elements configured to detachably couple the lid 302 and a wall of the container 310. In some embodiments, the container connection element 322 can be a hinge element extending fully or partially along an upper side of the sidewall 324A. In some embodiments, the lid connection element 327 can be a hinge element extending fully or partially along a sidewall of the lid 302 (e.g., between the first surface 304 and the second surface 306).

The container 310 can include a plurality of side walls 324 extending therearound and a bottom wall 312. The bottom wall 312 can include a first connection region 314 and a second connection region 316 extending along the container 310 at the intersection of the side walls 324 and the bottom wall 312. Although the first and second connection regions 314, 316 are shown, for example in FIG. 17, extending along opposing side walls 324A, in some embodiments, the first and second connection regions 314, 316 can be positioned along opposing side walls 324B.

The first and second connection regions 314, 316 can correspond to the first and second connection regions 209, 210 described in relation to the transport system 200 shown and described earlier, except where noted otherwise herein. As shown in FIG. 17, the container 310 includes a plurality of projections 320A-320F spaced longitudinally within the first connection region 314. One or more of the projections 320 can include a latch 321, which can be mechanically linked to an actuation mechanism 318. Actuating the actuation mechanism 318 can cause the latch 321 to protrude from or retract into the projections 320. The actuation mechanism 318 cab correspond to the actuation mechanism 211 described in relation to the transport system 200. The second connection region 316 can include projections that correspond to projections 214 of the second connection region 210 of the transport system 200. In some embodiments, the second connection region 316 can include projections 320 and at least one latch 321 that are configured similarly to those of the first connection region 314.

In some embodiments, the actuation mechanism 318 can be positioned on an opposite side of the container than is shown in FIGS. 16 and 17, such that the actuation mechanism can be mechanically coupled to latches of the second connection region 316, in addition to or alternatively from the configuration of the actuation mechanism 318 shown in FIGS. 16 and 17. In some embodiments, the actuation mechanism 318 can be positioned adjacent to sidewall 324B instead of sidewall 324A.

The lid 302 can include first and second receiving regions 326, 330 that can extend along opposing edges of the first surface 304 as shown in FIGS. 17 and 18. The first receiving region 326 can include a plurality of receiving cavities 328 positioned therein, such as receiving cavities 328A-328F. The receiving cavities 328 can include a recess therein and can be configured to receive the projections 320 (and/or the latches 321) positioned in the first connection region 314 when the lid 302 is coupled to the container 310. The second receiving region 330 can include a plurality of receiving cavities 332 positioned therein, such receiving cavities 332A-332F. The receiving cavities 332 can also include a recess therein and can be configured to receive projections and/or latches of the second connection region 316.

The first surface 304 of the lid 302 can also include a third connection region 334 that can extend longitudinally across some or all of the first surface 304. The third connection region 334 can include a plurality of projections 338 configured to securably couple or mate with a plurality of cavities 323 correspondingly positioned within a third receiving region 336 on a second surface 325 of the bottom wall 312 of the container 310, as shown in FIG. 16. Although the third connection region 334 and the third receiving region 336 are shown extending longitudinally along the second surface 325 of the container 310 and the first surface 304 of the lid 302, respectively, in some embodiments, the third connection region 334 and the third receiving region 336 can be located elsewhere on the second surface 325 of the container 310 and elsewhere on the first surface 304 of the lid 302. In some embodiments, there can be a plurality of third connection regions 334 on the second surface 325 of the container 310 and a corresponding plurality of third receiving regions 336 on the first surface 304 of the lid 302.

As shown in FIG. 18, the lid 302 has been removed from the container 310 and releasably secured to the bottom wall 312 thereof and the transport system 300 is in a deployed configuration ready to transport the container 310 and/or objects in the container 310 across a surface. In this configuration, the projections 320 (and latches 321) of the first connection region 314 have been received within the receiving cavities 328 of the first receiving region 326, projections of the second connection region 316 have been received within corresponding cavities 332 of the second receiving region 330, and the projections 338 of the third connection region 334 have been received within cavities 323 of the third receiving region 336.

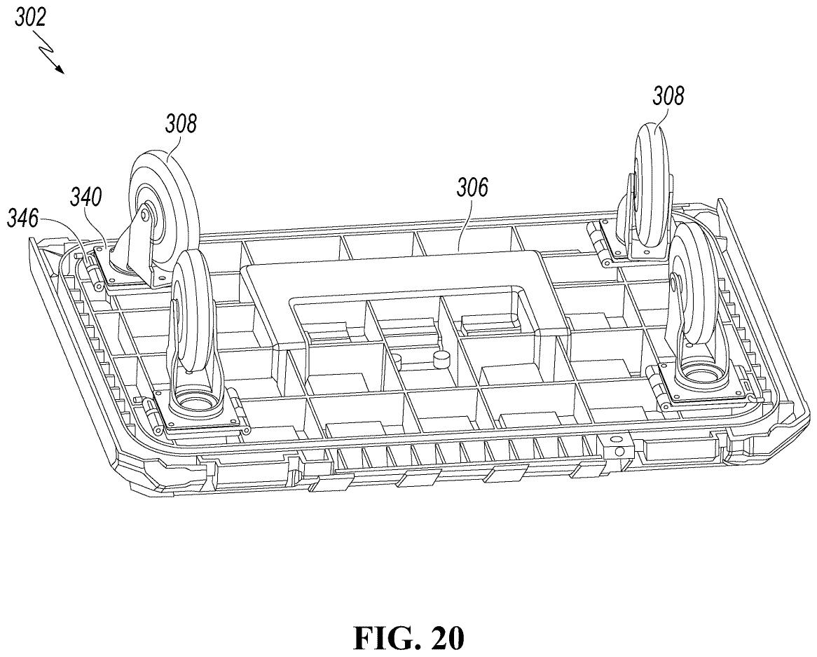

FIG. 19 illustrates the lid 302 and wheels 308 in a storage configuration, as envisioned when the lid 302 is detachably coupled to the container 310. Advantageously, the wheels 308 can include a number of features configured to aid storage and deployment of the lid 302 as a transport assembly. For example, as shown in FIG. 19, the wheels 308 can be included in a wheel assembly 340 affixed to the second side 306 of the lid 302. The wheel assembly 340 can include a first plate 342 that can be mounted to the second side 306 via one or more screws or bolts. A second plate 344 can be coupled to the first plate 342 via a hinge 352. The hinge 352 can allow the second plate 344 to articulate relative to the first plate 342. In this way, the wheel assembly 340 can be configured in a storage configuration as shown in FIG. 19 or in a deployed configuration as shown in FIG. 20. The wheels 308 can be rotatably coupled to the second plate 344. In some embodiments, one or more of the wheels 308 (and/or the wheel assembly 340) can include a lock mechanism, similar to lock mechanism 105 described herein. In some embodiments, the second side 306 of the lid 302 can include one or more clips or retaining mechanisms configured to secure the wheels 308 in place against the second side 306.

In some embodiments, the wheels 308 (and/or the wheel assembly 340) can be detachably coupled to the lid 302 and can be removed therefrom and affixed to a bottom wall of the container 310 for use in transporting the container 310 over a surface. The wheels 308 (and/or the wheel assembly 340) can be detachably coupled from the bottom wall of the container and coupled to the lid 302 after transport of the container 310 is complete. In some embodiments, the wheels 308 (and/or the wheel assembly 340) can include caster wheels, such as fixed caster wheels or articulating caster wheels configured to articulate relative the lid 302 or the bottom wall of the container 310. In some embodiments, the plurality of wheels 308 can include detachable caster wheels configured to couple to the lid 302 or the bottom wall of the container 310. In some embodiments, the plurality of wheels 308 can include detachable articulating caster wheels configured to couple to the lid 302 or the bottom wall of the container 310. Such detachable caster wheels and detachable articulating caster wheels may allow the wheels 308 to be selectively attached to or removed from the lid 302 or the bottom wall of the container 310 depending on the desired transport configuration.

The wheel assembly 340 can also include a hinge lock assembly 346 as shown in FIG. 19, which can be configured as an articulating wheel assembly 340 configured to translate relative to the lid 302 (or the bottom wall of the container 310 if detachably coupled thereto). The hinge lock assembly 346 can include a pin 348 on the first plate 340 and a receiving portion 350 on the second plate 344. To configure the lid 302 and the wheel assembly 340 for use as a transport assembly with the wheels 308 in the deployed configuration shown in FIG. 20, the second plate 344 can be articulated via the hinge 352 to abut the first plate 340. The pin 348 can be slidably engaged into the receiving portion 350 to secure the second plate 344 against the first plate 340. The first plate 340 can include a plurality of holes 354 therethrough in which screws or bolts can be used to secure the wheel assembly 340 to the second side 306 of the lid 302.

In some embodiments, a plurality of containers 204, 310 can be stacked upon one another to be transported via the transport assembly 100 (or the lid 302 when configured as a transport assembly).

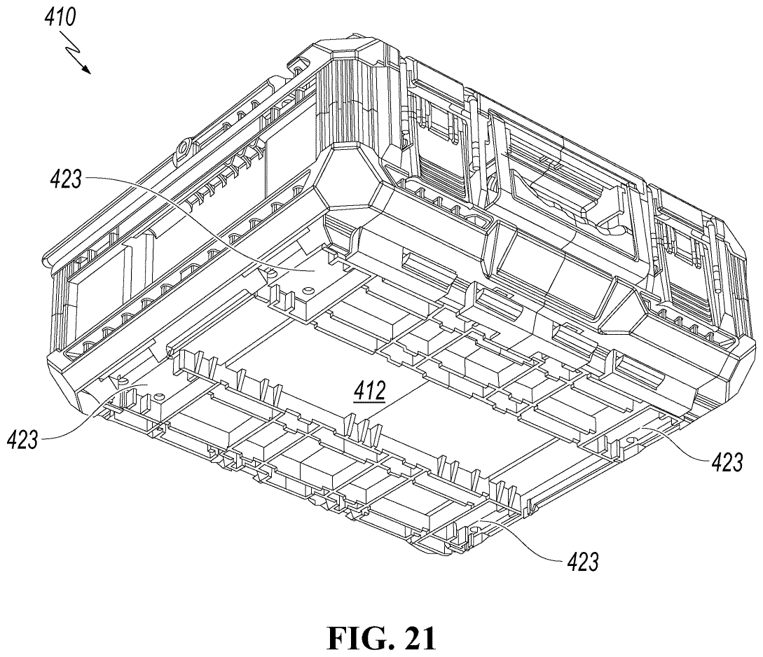

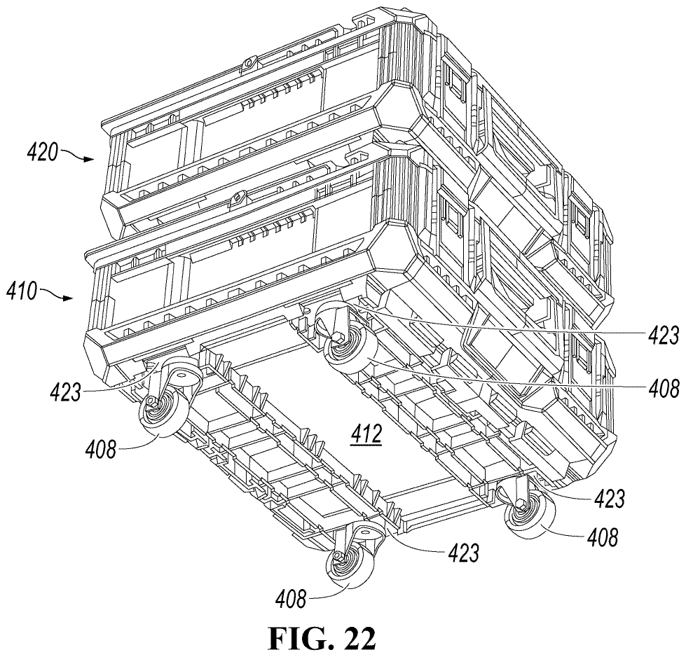

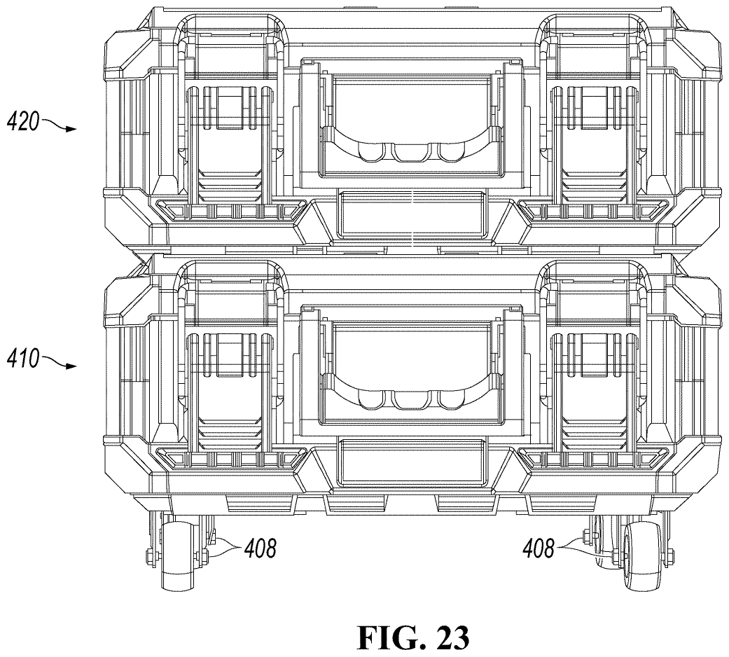

In some embodiments, the wheels of the transport assemblies described herein may be provided directly on the bottom wall of the containers. Such a variation is described in greater detail below in reference to FIGS. 21-23. FIG. 21 is an isometric view of another container 410, similar to the other containers described above, showing a bottom wall 412 of the container 410, which includes a plurality of cavities 423. Wheels 408, as shown in FIGS. 22-23, can be securely fastened to the bottom wall 412 via screws, bolts, or similar fastening mechanisms that extend through the bottom wall 412 or into threaded receptacles/busts formed therein. FIG. 22 is an isometric view of the container 410 of FIG. 21, with wheels 408 coupled to the bottom wall 412 thereof and with another container 420 securely coupled thereto. FIG. 23 is a front view of the container assembly of FIG. 22, showing the container 410 with wheels 408 coupled thereto, and the other container 420 securely coupled thereto. In some aspects, the wheels 408 can be configured to connect directly to the base of the container 410 adjacent to bottom corners of the container 410. For example, in some aspects the wheels 408 may be received directly within the plurality of cavities 423 provided on the bottom wall 412. In some aspects, the wheels 408 can be removably coupled to the bottom wall 412 via snap fittings, friction-fit connections, or similar releasable coupling mechanisms that allow the wheels 408 to be attached and detached without the use of tools. In some aspects, the wheels can be in the form of a wheel assembly 440, including the wheels 408, which can be configured to collapse via a hinge and hinge lock assembly, similarly to the wheel assemblies described above in reference to FIGS. 19-20. This configuration may allow the container 410 to be transported across a surface without requiring a lid to function as a transport assembly, thereby providing flexibility in the manner in which the container 410 can be moved.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

What is claimed is:

1. A transport assembly, comprising:
a support structure having first and second elongate support members operatively engaged with one another and movable between an expanded configuration and a collapsed configuration;
a plurality of wheels coupled to the support structure and configured to allowing rolling movement of the support structure along a surface when the support structure is in the expanded configuration; and
a connection assembly comprising a plurality of connectors positioned on the support structure, each of the plurality of connectors defining a recess configured to releasably engage with an object when the support structure is in the expanded configuration such that the support structure is configured to support the object during rolling movement of the support structure along the surface.

2. The transport assembly of claim 1, wherein the first and second elongate support members are operatively engaged with one another by a pivot joint.

3. The transport assembly of claim 2, wherein the pivot joint includes a first arc-shaped slot extending through the first elongate support member and a second arc-shaped slot extending through the second elongate support member.

4. The transport assembly of claim 3, wherein a first pin extends from a first side of the second elongate support member into the first arc-shaped slot and a second pin extends from a second side of the first elongate support member into the second arc-shaped slot, the first side of the second elongate support member opposite the second side of the first elongate support member.

5. The transport assembly of claim 3, wherein at least one of the first arc-shaped slot and the second arc-shaped slot includes a protrusion configured to secure the first and second elongate members in the expanded configuration.

6. The transport assembly of claim 1, wherein the plurality of wheels comprises a first pair of wheels positioned at opposite ends of the first elongate support member and a second pair of wheels positioned at opposite ends of the second elongate support member.

7. The transport assembly of claim 1, wherein each of the plurality of connectors is positioned adjacent to one of the plurality of wheels.

8. The transport assembly of claim 1, wherein each of the plurality of connectors comprises a first pair of connectors positioned at opposite ends of the first elongate support member and a second pair of connectors positioned at opposite ends of the second elongate support member.

9. The transport assembly of claim 8, wherein, when the support structure is in the collapsed configuration, each of the first and second pair of connectors are angularly oriented relative to one another, and wherein, when the support structure is in the expanded configuration, a first connector of the first pair of connectors and a first connector of the second pair of connectors are longitudinally aligned and a second connector of the first pair of connectors and a second connector of the second pair of connectors are longitudinally aligned.

10. The transport assembly of claim 9, wherein, when the support structure is in the collapsed configuration, the first connector of the first pair of connectors and the second connector of the first pair of connectors extend substantially parallel to the first connector of the second pair of connectors and the second connector of the second pair of connectors.

11. The transport assembly of claim 1, wherein the plurality of connectors are angularly oriented relative to one another when the support structure is in the collapsed configuration.

12. A transport assembly, comprising:
a first support unit, including a first side and a second side;
a first connection assembly positioned on the first side of the first support unit, the first connection assembly comprising a first connector having a first recess and a second connector having a second recess;
a first wheel connected at a first end of the second side of the first support unit;
a second wheel connected at a second end, opposite the first end, of the second side of the first support unit;
a second support unit, including a first side and a second side;
a second connection assembly positioned on the first side of the second support unit, the second connection assembly comprising a third connector having a third recess and a fourth connector having a fourth recess;
a third wheel connected at a first end of the second side of the second support unit;
a fourth wheel connected at a second end, opposite the first end, of the second side of the second support unit; and
a hinge assembly, comprising:
a first rod extending from the second side of the first support unit into a first slot of the second support unit, and
a second rod extending from the first side of the second support unit into a second slots of the first support unit.

13. The transport assembly of claim 12, wherein the second side of the first support unit and the first side of the second support unit include a recess substantially mid-way between the first and second ends of the first and second support units.

14. The transport assembly of claim 12, wherein the first and second support units are moveable between a collapsed position and an expanded position responsive to articulation of the hinge assembly around a pivot point defined by a third rod extending through the first and second support units.

15. The transport assembly of claim 12, wherein the first and second recesses of the first and second connectors are configured to retain an object therein.

16. The transport assembly of claim 12, wherein the first and second slots include an arc-shaped slot defining a range of motion of first and second support units relative to one another.

17. The transport assembly of claim 16, wherein at least one arc-shaped slot includes a protrusion defining a terminal position of the range of motion, the protrusion configured to secure the second rod within the slot when the first and second support units are in an expanded position.

18. A transport system, comprising:
a transport assembly, including a first elongate support member and a second elongate support member coupled to one another via a hinge assembly positioned substantially mid-way along the first and second elongate support members and extending therethrough, the hinge assembly configured to move the first and second elongate support members between a collapsed position and an expanded position, each of the first and second elongate support members including first and second wheels and first and second connectors positioned at opposing ends thereof; and
at least one container configured to releasably couple with the transport assembly, the at least one container having a plurality of sidewalls extending therearound between a top wall and a bottom wall of the at least one container and defining an inner volume of the container, the transport assembly configured to be retained within the inner volume when the hinge assembly is in the collapsed position and to receive the at least one container thereupon such that bottom wall is releasably coupled with the first and second connectors of the first and second elongate support members when the hinge assembly is in the expanded position.

19. The transport system of claim 18, wherein the bottom wall of the at least one container includes a plurality of projections extending along opposing edges of the bottom wall and configured to be received within the first and second connectors of the first and second elongate support members.

20. The transport system of claim 18, wherein in the collapsed position, recesses of the first and second connectors of the first elongate support member are angled relative to recesses of the first and second connectors of the second elongate support member and in the expanded position, the recesses of the first and second connectors of the first elongate support member are opposite to the recesses of the first and second connectors of the second elongate support member.

21.-27. (canceled)
